(19) United States
(12) Patent Application Publication
(10) Pub. No.: US 2019/0181545 A1
(43) Pub. Date: Jun. 13, 2019

(54) LUMINAIRE WITH RADIO FREQUENCY TRANSPARENT CAVITY

(71) Applicant: ABL IP Holding LLC, Conyers, GA (US)

(72) Inventors: Min-Hao Michael LU, Castro Valley, CA (US); John ENGLAND, San Francisco, CA (US)

(21) Appl. No.: 15/837,158

(22) Filed: Dec. 11, 2017

(51) Int. Cl. H01Q 1/44; H05B 37/02; F21V 23/04; H01Q 1/42

(52) U.S. Cl. CPC H01Q 1/44; H05B 37/0272; F21S 8/026; H01Q 1/42; F21V 23/0435

(57) ABSTRACT

The examples of luminaires include radio frequency (RF) circuitry, an antenna, a light source and a housing. The radio frequency circuitry is configured to emit or receive RF signals. The antenna is coupled to the RF circuitry and located at a back wall of the housing opposite a housing output aperture. The light source may be located at a housing perimeter closer in proximity to the output aperture. The light source may be configured to emit light for general illumination of a space. The housing encloses an RF radiation transparent volume substantially free of RF radiation interfering materials. The volume may extend from the antenna to the housing output aperture. Examples also include an RF transparent reflector to reflect light emitted by the light sources. Light and RF radiation may pass through the RF transparent volume and the housing output aperture.

### TECHNICAL FIELD

The present subject matter relates to technologies that provide improved radio frequency performance of a luminaire equipped with a radio frequency device.

### BACKGROUND

In recent years, the use of wireless communication systems to deliver or exchange data with mobile user devices, such as smartphones and tablet, within indoor locations have become more prevalent. Wireless networks have also been used to provide communications for building management and control functions, such as HVAC systems control, lighting system control, and/or building or area access control, as well as other functions, such as asset and inventory tracking, theft-prevention control functions radio frequency (RF), and the like.

Light fixtures within indoor locations are ubiquitous and have become increasingly sophisticated. Lighting fixtures have been equipped with wireless (optical and/or RF) detectors as well as RF receivers and/or transceivers for a number of reasons, such as to control the light sources of the light fixture, provide access to a data communication network, utilize a location determination service or the like.

The traditional back-lit, luminaire architecture has a number of elements, such as light sources and associated circuit boards, metalized diffuser elements, internal reflector elements, or the like, that interfere with RF signals emitted by and received by antennas within the luminaire.

While some implementations place the antenna in front of the light sources and associated circuit boards in an attempt to improve RF performance, such implementations have typically used antennas that are omnidirectional in which case RF performance is degraded by the presence of interfering materials within the luminaire. In addition, such implementations have to accommodate the illumination occluding effects of the antenna being in front of the light source.

### SUMMARY

Hence, a need exists for a luminaire configuration that is substantially free of RF radiation interfering materials in the RF path to/from the antenna and that outputs light meeting the lighting requirements for the space in which the luminaire is located.

By way of an example, a luminaire includes a housing, visible light sources, and an RF antenna. The housing having a back wall and a housing output aperture at a front of the housing. The housing enclosing an RF transparent volume may that may be at least substantially free of RF radiation interfering materials and at least substantially transparent with respect to the RF radiation, and the RF transparent volume being at least substantially transmissive with respect to visible light. The visible light sources may be mounted within the housing along at least a portion of the perimeter of the housing output aperture, and oriented to direct substantial emissions of visible light from the light sources into the RF transmission volume for combination and output of combined light from the light sources via the housing output aperture. The RF antenna may be mounted near a back wall of the housing opposite the aperture and coupled to the volume for transmission and/or reception of RF radiation through the aperture and the volume.

By way of another example, a luminaire includes radio frequency circuitry, an antenna, a housing and a light source. The radio frequency circuitry may be configured to emit or receive radio frequency signals. The antenna may be coupled to the radio frequency circuitry. The housing may have a back wall opposite a housing output aperture, and the housing may contain the antenna affixed to the back wall. The housing includes an RF radiation transparent volume substantially free of RF radiation interfering materials. The volume extends from the antenna at the housing back wall to an RF radiation transparent aperture in the housing output aperture. The light source may be configured to emit light for general illumination of a space in which the luminaire is located. The light source may be located at a perimeter of the housing in closer proximity to the housing output aperture than to the back wall.

Additional objects, advantages and novel features of the examples will be set forth in part in the description that follows, and in part will become apparent to those skilled in the art upon examination of the following and the accompanying drawings or may be learned by production or operation of the examples. The objects and advantages of the present subject matter may be realized and attained by means of the methodologies, instrumentalities and combinations particularly pointed out in the appended claims.

### BRIEF DESCRIPTION OF THE DRAWINGS

The drawing figures depict one or more implementations in accordance with the present teachings, by way of example only, not by way of limitation. In the figures, like reference numerals refer to the same or similar elements.

FIG. 1A is a high-level cross sectional view of an example of a luminaire having a volume that is at least substantially free of radio frequency (RF) radiation interfering materials and at least substantially transparent with respect to radio frequency RF energy going to or coming from an antenna of the luminaire coupled to the volume.

FIG. 1B is a high-level plan view through a diffuser of an example of the luminaire of FIG. 1.

FIG. 2 is a high-level cross sectional view of another example of a luminaire having a volume that is at least substantially free of RF radiation interfering materials, and has a lower cross-sectional profile than the luminaire example shown in FIG. 1A.

FIG. 3 is a high-level cross sectional view of another example of a luminaire that includes radio frequency components external to a reflector within the luminaire, and having a volume that is at least substantially free of RF radiation interfering materials and at least substantially transparent with respect to radio frequency RF.

FIG. 4 is a high-level cross sectional view of another example of a luminaire that includes radio frequency components external to a reflector within the luminaire, and having a volume that is at least substantially free of RF radiation interfering materials and at least substantially transparent with respect to radio frequency RF.

### DETAILED DESCRIPTION

In the following detailed description, numerous specific details are set forth by way of examples in order to provide a thorough understanding of the relevant teachings. However, it should be apparent that the present teachings might be practiced without such details. In other instances, well known methods, procedures, components, and/or circuitry have been described at a relatively high-level, without detail, in order to avoid unnecessarily obscuring aspects of the present teachings.

A luminaire implementation disclosed herein provides a substantially unobstructed radio frequency signal pathway from or to a radio frequency antenna installed within the luminaire to or from an RF-enabled device near the luminaire.

In the example light fixture type luminaires, the antenna for RF applications is mounted inside the luminaire housing at a location opposite an output aperture of the housing that is intended for light output and for wireless RF signal input or output. The interior volume of the fixture between the antenna and the output aperture is as clear as practical of materials that otherwise might substantially interfere with wireless RF signals. If there are materials between the antenna and the exterior space to be illuminated by the luminaire, such as a diffuser or light guide at or near the aperture, the materials are chosen for such components that are substantially non-interfering relative to wireless RF signals. The interior volume having the non-interfering materials that is produced by the location of the antenna inside the housing with respect to the housing output aperture may also be referred to as an RF transparent volume. The RF transparent volume has a boundary that is substantially coplanar with the output aperture of the housing.

The housing aperture may be a physical opening through a wall of the housing. In some examples, however, the housing aperture is solid or covered by a solid that is transmissive with respect to illumination light and RF radiation, e.g. a suitable material forming a diffuser or a light guide.

The adverb “substantially” is intended to indicate that the words being modified are not absolute in their definitions. For example, “substantially transparent” means transparent to a particular degree, such as greater than approximately 85 percent, of transparency. More specifically, an RF transparent volume and aperture may be greater than approximately 85 percent transparent to RF radiation, and, in such a case, the RF transparent volume may be considered to contain “substantially non-interfering” materials or be “substantially free of RF radiation interfering” materials. In addition, terms such as “transparent” are also intended to mean “less than completely transparent.” Alternatively, “substantially RF transparent” may also mean that RF signals are not noticeably attenuated by material within the RF transparent volume or by components that may be within the RF volume, such as a light guide and/or diffuser, to diminish or adversely affect antenna or radio system performance.

In the illustrated examples, there may be ambient air filling the RF transparent volume. If free of conductive contaminants or the like, air is sufficiently non-interfering to be considered transparent with respect to RF radiation and sufficiently transmissive with respect to visible light for purposes of this discussion. Some other materials that may be in the RF transparent volume or within the housing but in or adjacent to the RF transparent volume also may be sufficiently non-interfering to be considered transparent with respect to RF radiation and sufficiently transmissive with respect to visible light. Examples of such materials include glass, or acrylic or other non-conductive plastic materials like those used to form a diffuser or light guide.

The term “luminaire,” as used herein, is intended to encompass essentially any type of device that processes energy to generate or supply artificial light, for example, for general illumination of a space intended for occupancy or observation, typically by a living organism typically a human that can take advantage of or be affected in some desired manner by the light emitted from the device. However, a luminaire may provide light for use by automated equipment, such as sensors/monitors, robots, etc. that may occupy or observe the illuminated space, instead of or in addition to light provided for an organism. However, it is also possible that one or more luminaires in or on a particular premises have other lighting purposes, such as signage for an entrance or to indicate an exit. In most examples, the luminaire(s) illuminate a space or area of a premises to a level useful for a human in or passing through the space, e.g. general illumination of a room or corridor in a building or of an outdoor space such as a street, sidewalk, parking lot or performance venue. The actual source of illumination light in or supplying the light for a luminaire may be any type of artificial light emitting device having suitable light emission characteristics.

The illumination light output of a luminaire, for example, may have an intensity and/or other characteristic(s) that satisfy an industry acceptable performance standard for a general lighting application. The performance standard may vary for different uses or applications of the illuminated space, for example, as between residential, office, manufacturing, warehouse, or retail spaces.

In several illustrated examples, such a luminaire may take the form of a light fixture, such as a pendant or drop light or a downlight, or wall wash light or the like. Other fixture type luminaire mounting arrangements are possible. For example, at least some implementations of the luminaire may be surface mounted on or recess mounted in a wall, ceiling or floor. Orientation of the example luminaires and components thereof are shown in some of the drawings and described below by way of non-limiting examples only. The luminaire with the lighting component(s) may take other forms, such as lamps (e.g. table or floor lamps or street lamps) or the like. Additional devices, such as fixed or controllable optical elements, may be included in the luminaire, e.g. to distribute light output from the light source in a particular manner.

The term “coupled” as used herein refers to any logical, physical or electrical connection, link or the like by which signals produced by one element are imparted to another “coupled” element. Unless described otherwise, coupled components, elements or devices are not necessarily directly connected to one another and may be separated by intermediate components, elements, devices or communication media that may modify, manipulate or carry the signals.

Reference now is made in detail to the examples illustrated in the accompanying drawings and discussed below.

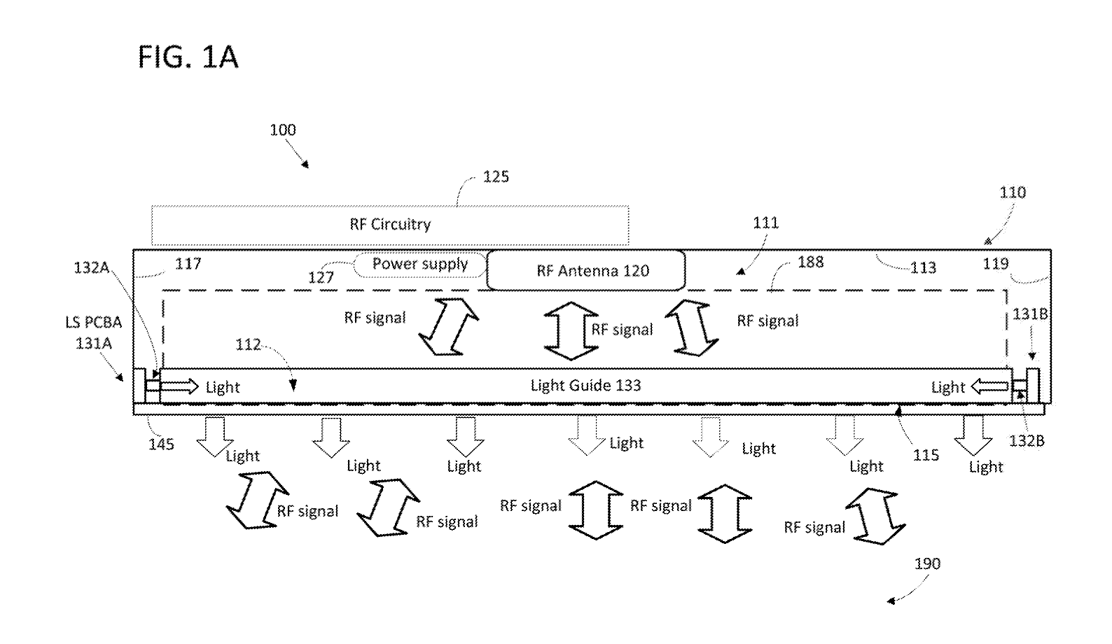

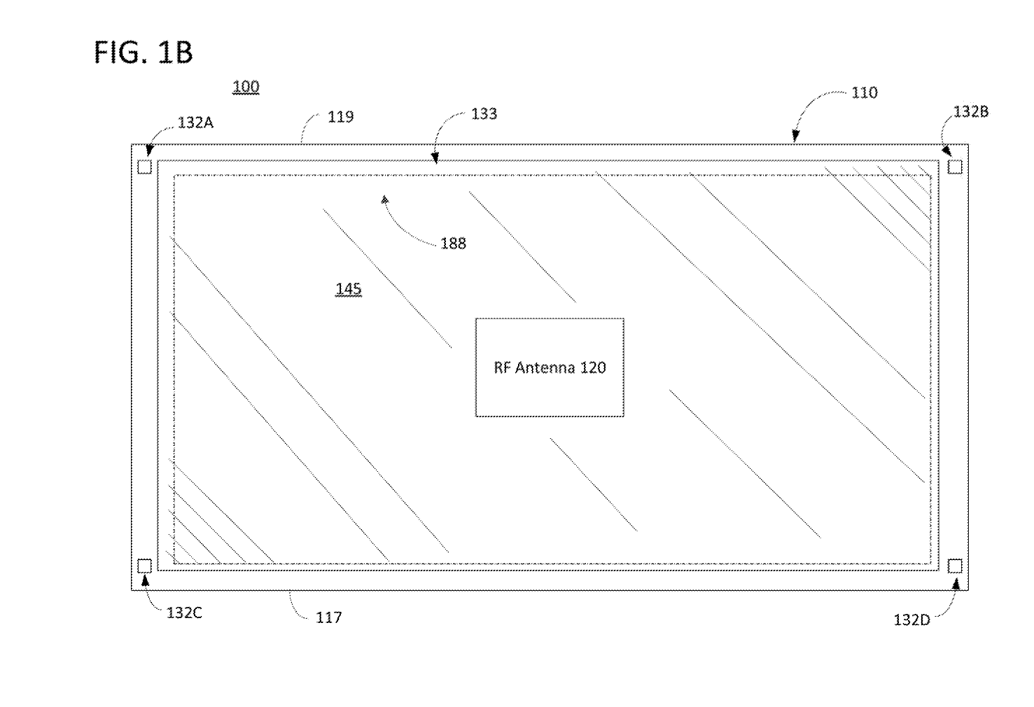

FIG. 1A is a high-level cross-sectional view of an example of a luminaire having a volume that is at least substantially free of radio frequency (RF) radiation interfering materials and at least substantially transparent with respect to radio frequency RF.

As shown in the cross-sectional view of FIG. 1A, the luminaire 100 includes a housing 110, visible light sources 132A and 132B, and a radio frequency antenna 120. The luminaire includes RF electronic circuitry 125, power supply 127 and RF antenna 120.

The housing 110 may be configured to form an enclosed RF transparent volume 188 that may extend from in front of the antenna 120 to the housing output aperture 115. The housing output aperture 115 may be located at the end of the housing sides 117 and 119 or substantially between the light guide 133 and diffuser 145. As such, the light guide 133 may be positioned inside the volume 188 adjacent to the housing output aperture 115.

The light guide 133 may be configured to receive and combine the substantial emissions of visible light from the light sources and direct the output of combined light from the light sources via the housing output aperture 115. The volume 188, for example, is at least substantially free of RF radiation interfering materials and at least substantially transparent with respect to RF radiation. The volume 188 is also at least substantially transmissive with respect to visible light such as the light emitted by the light sources 132A and 132B.

The housing 110, for example, has a mechanical design suitable for integrating a large radio frequency antenna 120 into the luminaire 100, and that creates enough volume inside the luminaire 110 to house components without impacting the illumination output from the luminaire 100. The housing 110 forms an interior space that includes the substantially RF transparent volume 188 that is free of RF interfering materials. The housing 110 may have a region or portion 112 adjacent to the housing output aperture 115 and an opposite region, or portion 111 adjacent to the back wall 113. The housing 110 may contain the RF antenna 120. For example, the RF antenna 120 may be located at or mounted near the back wall 113 of the housing 110 opposite the housing output aperture 115 and coupled to the volume 188 for transmission and/or reception of RF radiation through the housing output aperture 115 and the volume 188. The housing 110 may, for example, have sides 117, 119 coupled to the housing back wall 113 and housing output aperture 115. The housing back wall 113 may be a wall of the housing 110 at which the RF antenna 120 is located, while the housing output aperture 115 is a part of the housing 110 from which the illumination light and signals are output from the luminaire 100. In the example of FIG. 1A, the housing sides 117, 119 may be configured to extend perpendicularly from the housing back wall 113 to the housing output aperture 115. The housing sides 117, 119 may be coupled to the housing back wall 113 and housing output aperture 115 using a number of different techniques and/or coupling devices, such as welding, screws, interconnecting tabs and slots, or the like.

The visible light sources 132A and 132B may respectively be coupled to a light source (LS) printed circuit board assembly (PCBA) 131A and 131B. The LS PCBA 131A and 131B may control the operation of the light sources 132A and 132B. The light sources 132A and 132B emit light into a light guide 133 for general illumination of a space 190 in which the luminaire 100 is located. The light sources 132A and 132B may be located at a perimeter of the housing 110 in proximity closer to the housing exterior portion 112 than the housing interior portion 111. For example, the light source 132A may be located approximately at an interior intersection of the housing output aperture 115 and housing sides 117, 119.

FIGS. 1A and 1B relate to an edge lit type lighting device. This type of lighting device is colloquially referred to as “edge” lit or as an “edge light” in that the source of illumination light is coupled to a periphery, e.g. around an edge, of a light guide 133 that outputs the illumination light. In actual implementations, such as that shown, one or more light sources that together form the source of illumination light are coupled to one or more lateral surfaces along the periphery of the light guide 133, for example, formed between peripheral edges of longitudinal surfaces of the light guide 133. The illumination light sources 132A and 132A in the example includes a number of lighting LEDs, supported along the periphery of the light guide 133.

Light waveguides, also sometimes referred to as “light guides” or “light pipes,” are known in the lighting arts. For example, a light guide, such as 133, may utilize internal reflections governed by Snell's Law. The light guide 133 may, for example, be fabricated of a clear light and RF transmitting material, such as clear polycarbonate, polymethyl methacrylate (PMMA), silicone, glass, acrylic, or other clear plastic having opposing surfaces (top and bottom surfaces in the drawing) between which the light is internally guided. The light guide 133 also includes one or more lateral surfaces through which light can be introduced into the guide from one or more light sources coupled to the ‘edge’ surface(s). Because of the high angle of incidence (angle from an axis perpendicular to the respective surface) of light rays at the longitudinal surfaces of the light guide body, the light rays will internally reflect off of these surfaces and consequently will not escape the guide. In this way, the internal reflections, at longitudinal surfaces of the guide structure, channel or guide light introduced at one or more lateral or peripheral surfaces along the light guide 133, often without emerging from the guide's lateral surfaces except at desired specially configured output locations.

In the illustrated example, a body of the light guide 133 is at least substantially planar. In the specific example shown, a longitudinal output surface and a longitudinal opposite surface of the guide 133 are planar surfaces that are actually parallel to each other, although there may be some minor deviation due to the process of forming those surfaces of the material forming the body of the light guide 133. There may also be applications in which either one or both surfaces on the body of the light guide 133 has a non-planar contour, such as concave, convex or exhibiting a recurring light form (e.g. sinusoidal or sawtooth). The light guide 133 as described herein is intended to output the light emitted by the light sources 132A and 132B out of the luminaire 100 to illuminate the space 190 up to a level that satisfies governmental (e.g., Occupational Safety and Health Administration (OSHA)) and industry standards (e.g., American National Standards Institute)).

Also, the plan view (FIG. 1B) shows a luminaire 100 having a rectangular shape, of course, the luminaire 100 and appropriate components thereof may have other shapes, e.g. circular, oval square, hexagonal, or the like. The drawings also show some representative examples of scale and spatial relationships, although implementations of the luminaire may exhibit other sizes/relationships.

As shown in FIG. 1B, the light sources 132A and 132B as well as light sources 132C and 132D are located beyond a perimeter of the RF radiation transparent volume 188 and housing output aperture 115. The RF radiation transparent volume 188 being at least substantially free of radio frequency (RF) radiation interfering materials meaning that materials, if any, in the volume do not substantially interfere with the transmission of, or noticeably attenuate, RF signals passing through the volume 188. In the example shown in FIG. 1A, the RF radiation transparent volume 188 may extend from the antenna 120 to the housing output aperture 115 in a first direction, and may extend in a second direction between the light sources 132A and 132B.

The light guide 133 may be configured to receive and combine the substantial emissions of visible light from the light sources 132A and 132B, and direct the output of combined light from the sources via the housing output aperture 115 (shown in FIG. 1A). The light guide 133 may be mounted in the RF radiation transparent volume 188 adjacent to or across the housing output aperture 115. The light guide 133 may also be described as being located near the exterior portion 112 of the housing 110, or above the diffuser 145. In some examples, the diffuser 145 is substantially transparent to RF radiation meaning that the diffuser 145 is formed of a light diffusing material that does not substantially interfere with the transmission of, or noticeably attenuate, RF signals passing through the diffuser 145. In an example, the diffuser 145 as well as the light guide 133 may be within the RF radiation transparent volume 188.

As shown in FIG. 1B, the light sources 132A-132D may be mounted within the housing 110 along at least a portion of the perimeter of the aperture (such as 189 of FIG. 1, but not shown in this example) and oriented to direct substantial emissions of visible light from the sources 132A-132D into the volume via the light guide 133 for combination and output of combined light from the sources via the aperture. The light guide 133 may, for example, facilitate the use of light emitting diode (LED) light sources, such as 132A-D, to provide the general illumination lighting into the space, such as 190 shown in FIG. 1A, in which the luminaire 100 is located. Each of the light sources 132A, 132B, 132C and 132D are shown in FIG. 1A as being located in the corners of housing 110. However, the light sources 132A-132D may be positioned elsewhere to facilitate a desired distribution of light for general illumination or task lighting.

The luminaire 100 may also include a diffuser 145 formed from a light diffusing material that is transparent to RF radiation. The diffuser 145 may be supported by the bottom 115 of the housing 110. As shown in the example of FIG. 1B, the diffuser 145 may extend across all or at least a substantial portion of the housing output aperture 115. Alternatively, the diffuser 145, depending upon the desired aesthetics for the luminaire 100, may extend a part or parts of the housing output aperture 115 thereby leaving the volume 188 open to the space 190.

Returning to the example of FIG. 1A, the luminaire 100 may also include radio frequency (RF) circuitry 125. The RF antenna 120 may be coupled to the RF circuitry 125. A power supply 127 may provide electrical power to the RF circuitry 125. For example, the power supply 127 may be coupled to AC mains or other form of power supply, such as battery, solar cell, or the like. The RF circuitry 125 may be configured to emit or receive radio frequency signals via the RF antenna 120. For example, the RF circuitry 125 and the RF antenna may be configured to transmit/receive in frequencies associated with radio frequency identification (RFID), Bluetooth®, ZigBee®, Wi-Fi, or ultra wideband (UWB) radio or radar and the like. For example, the luminaire 100 may include a radio frequency identifier (RFID) reader circuit (not shown), which may include an RFID transceiver (not shown). The RF transceiver, for example, may supply RF signals to and/or obtain RF signals via the RF antenna 120. The details of an RF transceiver are unnecessary for the understanding of the present subject matter. However, examples of an RF transceiver suitable for use in the luminaire 100 and other luminaire examples include RF transceivers provided by Texas Instruments®, Analog Devices®, Maxim®, Renesas®, Hittite® or Broadcom®. In addition, the RF circuitry 125 may be configured to couple to a lighting control network for RFID data transmission, and/or may use a common power supply, such as 127, to power RFID and lighting components.

As shown in FIG. 1A, the RF antenna 120 may be affixed to a back wall 113 of the housing 110 opposite the housing output aperture 115 and coupled to the volume 188 for transmission and/or reception of RF radiation through the volume 188 and the housing output aperture 115. In some examples, the RF antenna 120 may not substantially protrude into the volume 188. In an example, the light source(s) 131A, 131B and the radio frequency identifier reader circuitry 125 are located outside the RF radiation transparent volume 188. By positioning the RF antenna 120 in the housing and the RF circuitry 125 outside the housing 110, potential sources of RF interference (e.g. circuit boards, radio frequency sources and the like) may be moved farther from the RF antenna. The RF antenna 120 may be enclosed with an RF transparent antenna enclosure (not shown) having a form factor such as an approximately 6 inch to 8 inch square, other polygon or another shape, such as circular or elliptical. More specific examples of an antenna may include a patch antenna, dipole antenna, chip antenna, or arrays thereof. The RF transparent enclosure containing the RF antenna 120 may be affixed to the housing 110 via any known method or device(s).

The housing 110 may be formed of an RF transparent material, such as rigid or structurally molded (e.g., honey-combed, diamond-shaped) plastics or the like, that replaces a metallic frame typically included with light fixtures. In addition, areas about the center of the luminaire 110 may contain electrically non-conductive materials to further eliminate possible sources of interference.

By arranging the associated RF circuitry 125 outside of the housing 110 and positioning the LEDs 132A, 132B and related LED PCBA 131A, 131B around the interior perimeter of the luminaire housing LEDs, an RF transparent volume 188 substantially in the center of the luminaire housing 110 is provided. The RF transparent volume 188 allows RF signals to pass through (e.g., in and out of the RF transparent volume) without minimal interfering structures present while also passing visible light for illumination of a space in which the luminaire 100 is located. The RF antenna 120 that is located at the housing back wall 113 and the volume 188 is intended to be large enough to allow for adequate dispersion of the RF signals emitted by the RF antenna 120. The configuration of the luminaire 100 as shown in FIGS. 1A and 1B and described herein provides improved transmission and reception performance of the RF antenna 120 within the luminaire 100.

The visible light output from the luminaire 100 in intended to provide illumination that conforms to governmental and industry standards for illumination suitable for the particular space in which the luminaire is located. For example, if the luminaire 100 is installed in a warehouse setting, the illumination provided by the luminaire conforms to the governmental and industry standards for a warehouse.

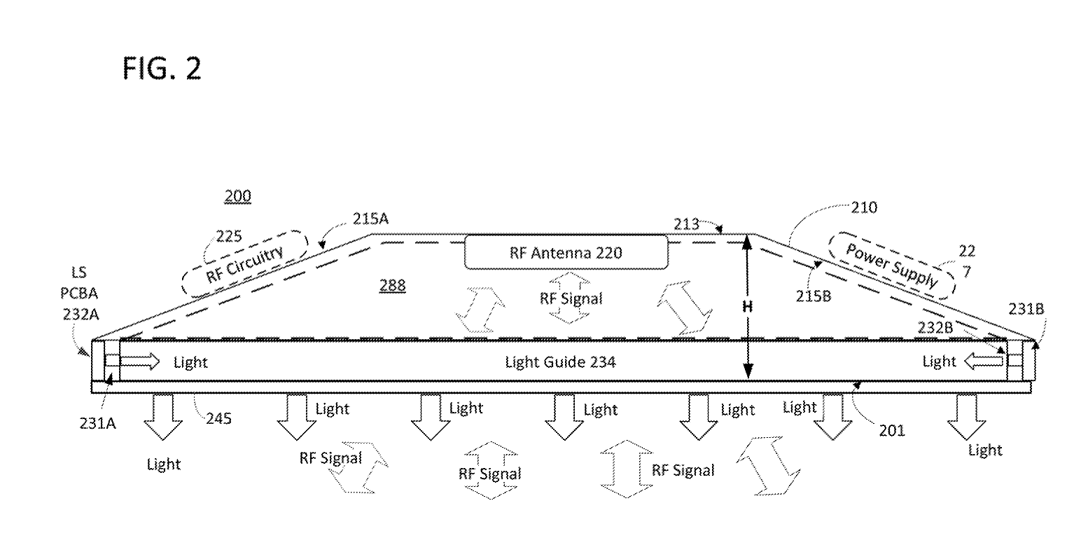

While luminaire configurations as described with reference to FIGS. 1A and 1B may be appropriate for some installations having high ceilings, deep walls, large wall-mounted lighting fixtures, or drop ceilings with expansive voids, other configurations of the housing 110 that accommodate installation locations with limited area are also envisioned. For example, FIG. 2 provides a high-level cross sectional view of an example of a luminaire having a volume being substantially free of RF radiation interfering materials and substantially transparent with respect to RF radiation, and has a lower cross-sectional profile than the luminaire example shown in FIG. 1A.

The luminaire 200 of FIG. 2 has substantially similar features as the luminaire of 100 of FIG. 1. The luminaire 200 may be configured in the form of a trougher-type light fixture having dimensions such as 4 feet×4 feet, 2 feet×2 feet, 1 foot×4 feet, or the like. The luminaire 200 includes a housing 210, an RF antenna 220, a light guide 234, light sources (LS) 232A and 232B, light source printed circuit board assembly (LS PCBA) 231A and 231B, and a light guide 234.

The light guide 234 may be mounted outside the RF radiation transparent volume 288. Alternatively, the RF radiation transparent volume 288 may extend to include the light guide 234. The light guide 234 may be configured to receive and combine the substantial emissions of visible light from the light sources 231A and 231B, and direct the output of combined light from the light sources 232A and 232B via the housing output aperture 201. The light sources 232A and 232B may be located beyond a perimeter of the RF radiation transparent volume 288, and therefore, do not interfere with RF signals within the volume 288.

A luminaire configuration as shown in FIGS. 1A-2 utilizes a type of light engine (e.g., LS PCBA, such as 131A, and LS, such as 132A) located along a perimeter around the luminaire housing of the luminaire enables the integration of a type of RF or other radiation electromagnetic antenna, such as 120 or 220, that is larger than a thin wire antenna or the like into the luminaire.

The housing 210 may have a housing output aperture 201 and a housing back wall 213 that is coupled to housing sides 215A and 215B. Unlike housing 110 of FIG. 1 that has sides 117 and 119 that are perpendicular to the housing back wall 213, the housing sides 215A and 215B of luminaire 200 are at obtuse angles with respect to the housing back wall 213. Or, said differently, the respective sides 215A and 215B of the housing 210 form acute angles with respect to the light guide 234. In general, the housing sides 215A and 215B are coupled to the housing top 213 at obtuse angles and to a point on the housing 210 at about the light sources 232A and 232B at which the respective sides 215A and 215B of the housing form acute angles with respect to the light guide 234. A benefit of this housing configuration enables the housing height, shown as dimension H, to be reduced as compared to, for example, a height (not shown) of the housing 110 of FIG. 1. As a result, the housing 210 configuration of FIG. 2 allows for installation of RF transparent luminaire in locations with reduced void spacing, such as a wall or low ceiling heights.

The RF antenna 210 may be configured to emit frequencies in the ranges compatible with RFID, BLE, Wi-Fi or other electromagnetic radiation that may be emitted from an RF antenna 220 is physically located in the luminaire 200. The RF antenna 220 may be located at the center of the luminaire 200. The RF antenna 220 coupled to the housing back wall 213 and opposite the housing output aperture 201. The diffuser 245 is positioned at the housing output aperture 201 to diffuse light output from the housing output aperture 201.

In the luminaire 200 example of FIG. 2, the RF circuitry 225 may be positioned on the exterior of the housing 210 at either side 215A or 215B of the luminaire. Similarly, the power supply 227 may also be positioned at the exterior of the housing 210 at either side 215A or 215B of the luminaire. Alternatively, the power supply 227 and the RF circuitry 225 may be located at the same side, such as 215A or 215B. The RF circuitry 225 may be radio frequency identifier reader circuitry is located outside the housing 210.

The diffuser 245 may be made from a light diffusing material that is transparent to RF radiation such that the diffuser 245 does not substantially interfere with, or noticeably attenuate, the passage of RF signals through the diffuser 245. The diffuser 245 may be supported by the housing 210 and may extend across at least a substantial portion of the housing output aperture 201. As such, the view of the interior of the luminaire housing 210 through the housing output aperture 201 of luminaire 200 may be similar to that of luminaire 100 shown in FIG. 1B.

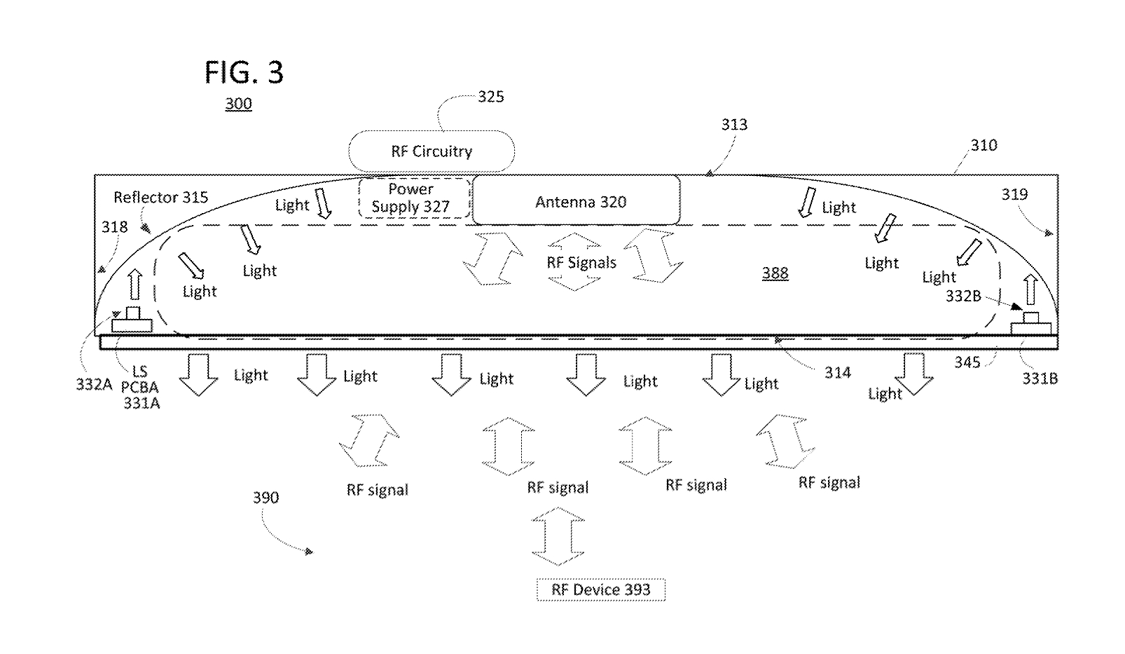

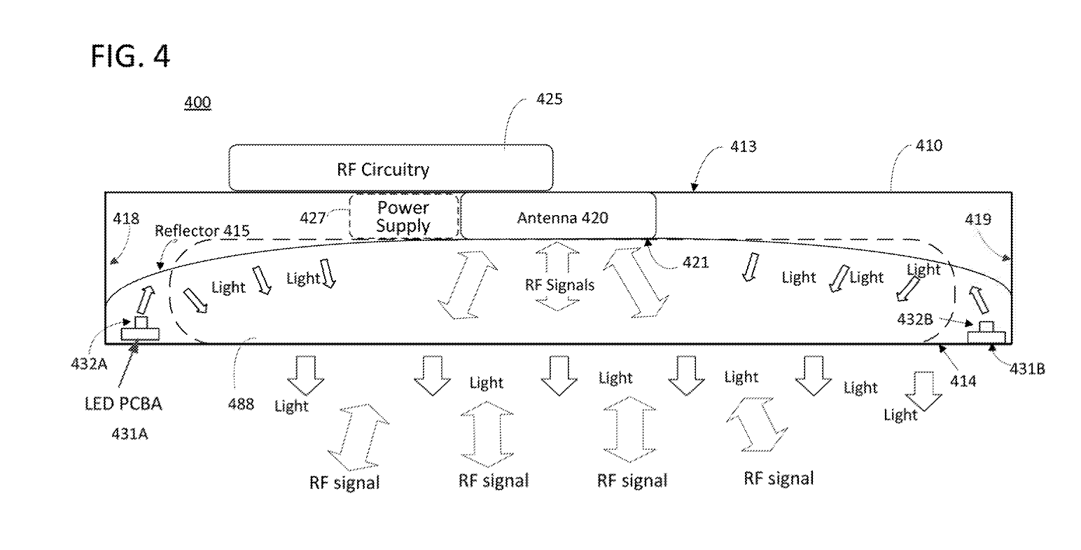

In addition to the different configurations of housings, such as 110 and 210, examples of a luminaire may incorporate additional structure that enhances the RF transparent volume already present and enhances the output of the general illumination light from the luminaire. The examples of FIGS. 3 and 4 illustrate the use of a reflector to enhance the RF capabilities as well as the illumination output capabilities of a luminaire.

FIG. 3 is a high-level cross sectional view of another example of a luminaire that includes radio frequency components external to a reflector within the luminaire, and having a volume being at least substantially free of RF radiation interfering materials and at least substantially transparent with respect to radio frequency RF.

The luminaire 300 includes radio frequency circuitry 325, an antenna 320, light sources 332A and 332B, a power supply 327, and reflector 315. The antenna 320 may be coupled to the radio frequency circuitry 325. The antenna 320 may be affixed to a back wall 313 of the housing 310.

In the example, the light sources 332A and 332B are coupled to a light source (LS) printed circuit board assembly (PCBA) 331A and 331B. The LS PCBA 331A and 331B are configured to supply power and control the supply of power to the light sources 332A and 332B. A discussion of the detailed operation of the LS PCBA 331A and 331B is unnecessary for an understanding of the luminaires as described herein, and will therefore be omitted. The light source 332A or 332B is located at a perimeter of the housing 310 in proximity close to an output aperture 314 of the housing 310. The light source 332A or 332B is configured to emit light for general illumination of a space 390 in which the luminaire 300 is located. The light sources 332A and 332B are further configured, from their respective positions beyond the perimeter of the RF radiation transparent volume 388 to emit light toward the reflector 315. The housing output aperture 314 encompasses an open space in the housing 310 through which the light emitted by the light source 332A or 332B and reflected by the reflector 315 is output as general illumination light to the space 390. The housing output aperture 314 also enables RF signals to pass into and out of the housing 310 substantially without interference. The light source 332A or 332B is located beyond a perimeter of the RF radiation transparent volume 388 as well as beyond the perimeter of the housing aperture 314.

The reflector 315 may be an internal reflector that may, for example, be mounted within the housing 310 to diffusely reflect the substantial emissions of visible light from the light source(s) 332A and/or 332B within the RF transparent volume 388 for the output of combined light from the sources 332A and 332B via the housing output aperture 314. The configuration of the reflector 315 may be such that the combined light is distributed substantially uniformly for emission from the housing output aperture 314 into the space 390 as general illumination or specific task lighting. For example, when the luminaire 300 is implemented as general illumination lighting the outputted light conforms to governmental and industry standards, while if selected for task lighting, the outputted light may have an intensity appropriate for the selected task. In an example, the reflector 315 is a non-specular and non-metallic reflector (e.g. diffusely reflective) configured to minimize interference, or attenuation, RF signals within the field of view of antenna 320. The antenna 320 may be affixed to the top of the reflector 315 substantially adjacent to the housing back wall 313. In other examples, when the reflector is mounted within the housing, the reflector may be positioned in front of the antenna, while in other examples, the reflector, when mounted within the housing, may be positioned closer to the back wall of the housing than the antenna. The reflector may also be partially within the RF transparent volume when mounted within the housing, or may be around the RF transparent volume.

The RF circuitry 325 may be coupled to a power supply 327 that is configured to supply electrical power to the RF circuitry 325. For example, the power supply 327 may receive power from AC mains (not shown) that supply electrical power to space 390, a battery, or other source of electricity. The power supply 327 may be located within the housing 310 in an area, such as any location substantially out of the field of view of the antenna 320. Alternatively, the power supply 327 may be located outside the housing 310, for example, as in the example of FIG. 2.

One benefit of the luminaire structure in the example of FIG. 3 is that such a configuration allows for integration of the antenna 320 in a luminaire 300 without substantially diminishing the performance of the antenna 320 or the illumination output of the luminaire 300. Examples of antennas suitable for use as antenna 320 may include antennas configured to communicate in frequencies associated with radio frequency identification (RFID), Bluetooth®, ZigBee®, Wi-Fi and the like. The antenna 320 is coupled to the radio frequency circuitry 325.

The radio frequency circuitry 325 is configured to emit or receive radio frequency signals, such as those associated with radio frequency identification (RFID), Bluetooth®, ZigBee®, Wi-Fi and the like. For example, the radio frequency circuitry 325 may include radio frequency identifier (RFID) reader circuitry. When the radio frequency circuitry 325 is configured as RFID reader circuitry, the RFID reader circuitry may include an RF transceiver (not shown). The RF transceiver supplies RF signals to and/or obtains RF signals via the antenna 320. The radio frequency identifier reader circuitry 325 is located outside the housing 310.

The housing 310 may include an RF radiation transparent volume 388 substantially free of RF radiation interfering materials. In the example of FIG. 3, the RF radiation transparent volume 388 extends from beneath the antenna 320 contained within the housing 310 to an RF radiation transparent aperture 389 at the housing output aperture 314. The housing output aperture 314 may be a substantially unimpeded pathway for RF signals into and out of the RF radiation transparent volume 388. In other examples, the RF radiation transparent volume 388 may include part of the antenna 320 and may or may not extend into the diffuser 345 below the housing output aperture 314. The housing output aperture 314 may be a point where the housing sides 318 and 319 end nearest to the housing output aperture 314.

The RF radiation transparent volume 388 is configured to pass RF signals substantially unattentuated or without radio frequency interference and in addition, is configured to pass the light reflected by reflector 315, the light initially being emitted by the light source(s) 332A or 332B for general illumination.

The housing output aperture 314 may be completely, or partially, covered by a diffuser 345. The diffuser 345 may include a light diffusing material, such as acrylic film or substrate, polycarbonate film or substrate, or the like, that is substantially transparent to RF radiation. In an example, the light source(s) 332A or 332B and the radio frequency identifier reader circuitry 325 are located outside the RF radiation transparent volume 388.

An RF device 393 may exchange signals with the RF circuitry 325 via antenna 320. The RF device 393 may, for example, be an RFID communication tag, a smartphone, a short-range handheld device, a computer peripheral device, such as a printer, copier, facsimile machine or the like, or any other wireless device that operates at a frequency compatible with the RF circuitry 325. Depending upon the configuration of the space 390, the RF signals to and from the RF device 393 may be interfered with, or attenuated, due to objects nearby the RF device 393. For example, if the RF device is a smart phone in a purse or pocket and thereby positioned closer to the floor of the space 390, a greater number of structures (e.g. metallic shelves, drop ceilings and the like) and objects (e.g. shopping carts, machinery, other RF sources, and the like) may interfere or attenuate the signals By providing an RF transparent volume in the luminaires, communication with the RF device 393 may be improved as the antenna field of view is greater in the disclosed luminaire examples.

In the example of FIG. 3, the reflector 315 extends from the housing output aperture 314 to the housing back wall 313. However, other reflector configurations within luminaires are also contemplated.

In the example of FIG. 4, the reflector 415 does not extend to the back wall 413 of the housing 410. Instead, the reflector 415 extends to a surface 421 of the antenna 420. The luminaire example of FIG. 4 includes elements similar to those shown in the luminaire 300 of FIG. 3. For example, the luminaire 400 includes radio frequency circuitry 425, an antenna 420, light sources 432A and 432B, a power supply 427, and the reflector 415. The antenna 420 and the power supply 427 may be coupled to the radio frequency circuitry 425. The light sources 432A and 432B may be configured in a similar manner as light sources 332A and 332B. In an example, the light source(s) 432A or 432B and the radio frequency identifier reader circuitry 425 are located outside the RF radiation transparent volume 488.

The RF radiation transparent aperture 489 is also configured to permit passage of the light emitted by the light source(s) 432A or 432B for general illumination. The luminaire 400 is shown without a diffuser. However, a diffuser, such as diffuser 345, that is transparent to RF radiation may be included.

The reflector 415 extends from one side 418 to the other side 419 of the housing 410, and is positioned to receive light emitted by the light sources 432A and 432B, and disperse the emitted light into the housing 410 and ultimately out of the luminaire 400.

In the example of FIG. 4, the RF radiation transparent volume 488 extends from beneath the antenna 420 contained within the housing 410 to the housing output aperture 414. In the example, the RF radiation transparent aperture 489 is located substantially on the same plane as the light sources 432A and 432B. The potential interference that may be caused by the light sources 432A and 432B and respective LS PCBAs 431A and 431B is minimized because of the light sources 432A and 432B and respective LS PCBAs 431A and 431B being located beyond a perimeter of the RF radiation transparent aperture 489.

Other than the absence of a diffuser and the configuration of the reflector 415, the coupling of the RF circuitry 425, power supply 427 and antenna 420 in luminaire 400 are substantially similar to the coupling of the RF circuitry 325, power supply 327 and antenna 320 in luminaire 300, and therefore, a detailed discussion of the coupling of those elements is omitted for the sake of brevity.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain. For example, unless expressly stated otherwise, a parameter value or the like may vary by as much as ±10% from the stated amount.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” “includes,” “including,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus the following claims are hereby incorporated into the Detailed Description, with each claim standing on its own as a separately claimed subject matter.

While the foregoing has described what are considered to be the best mode and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present concepts.

What is claimed is:

1. A luminaire, comprising:
a housing having a back wall and a housing output aperture at a front of the housing, the housing enclosing a radio frequency (RF) transparent volume, the volume being at least substantially free of RF radiation interfering materials and at least substantially transparent with respect to the RF radiation, and the volume being at least substantially transmissive with respect to visible light;
visible light sources mounted within the housing along at least a portion of the perimeter of the housing output aperture and oriented to direct substantial emissions of visible light from the light sources into the volume for combination and output of combined light from the sources via the housing aperture; and
an RF antenna mounted near the back wall of the housing opposite the housing output aperture and coupled to the volume for transmission and/or reception of RF radiation through the housing output aperture and the volume.

2. The luminaire of claim 1, further comprising an RF transceiver for supplying RF signals to and/or obtaining RF signals via the RF antenna.

3. The luminaire of claim 1, further comprising a reflector mounted within the housing to diffusely reflect the substantial emissions of visible light from the sources for output of combined light from the sources via the aperture.

4. The luminaire of claim 3, wherein when the reflector is mounted within the housing, the reflector is positioned in front of the antenna.

5. The luminaire of claim 3, wherein when the reflector is mounted within the housing, the reflector is positioned closer to the back wall of the housing than the antenna.

6. The luminaire of claim 3, wherein the reflector is partially within the RF transparent volume when mounted within the housing.

7. The luminaire of claim 3, wherein the reflector is around the RF transparent volume.

8. The luminaire of claim 1, further comprising a light guide positioned outside the volume adjacent to the housing output aperture, configured to receive and combine the substantial emissions of visible light from the light sources and direct the output of combined light from the light sources via the housing output aperture.

9. The luminaire of claim 1, further comprising a light guide positioned inside the volume adjacent to the housing output aperture, configured to receive and combine the substantial emissions of visible light from the light sources and direct the output of combined light from the light sources via the housing output aperture.

10. The luminaire of claim 1, further comprising a light diffusing material that is substantially transparent to RF radiation, supported by the housing and extending across at least a portion of the housing output aperture.

11. The luminaire of claim 1, further comprising:
a radio frequency identifier (RFID) reader circuit,
wherein the RFID reader circuit includes the RF transceiver.

12. A luminaire, comprising:
radio frequency (RF) circuitry configured to emit or receive radio frequency signals;
an antenna coupled to the radio frequency circuitry;
a housing having a back wall opposite a housing output aperture, the housing containing the antenna affixed to the back wall of the housing; and
a light source located at a perimeter of the housing closer in proximity to the housing output aperture than to the back wall, the light source being configured to emit light for general illumination of a space in which the luminaire is located,
wherein the housing includes an RF radiation transparent volume substantially free of RF radiation interfering materials, the volume extending from the antenna to the housing output aperture.

13. The luminaire of claim 12, further comprising:
a light guide optically coupled to the light source, and configured to distribute the emitted light from the luminaire, wherein the light guide is substantially free of RF interfering materials.

14. The luminaire of claim 12, wherein the housing output aperture is configured to permit passage of the light emitted by the light source for general illumination and passage of RF radiation.

15. The luminaire of claim 12, wherein the housing output aperture is covered with a light diffusing material that is transparent to RF radiation.

16. The luminaire of claim 12, wherein the light source is located beyond a perimeter of the RF radiation transparent aperture.

17. The luminaire of claim 12, wherein the radio frequency circuitry is located outside the housing.

18. The luminaire of claim 12, wherein the light source is further located approximately at an intersection of the housing output aperture and housing sides.

19. The luminaire of claim 12, wherein the housing further comprises:
housing sides coupled to the housing back wall and the housing output aperture, and configured to extend perpendicularly from the housing back wall to the housing output aperture.

20. The luminaire of claim 12, wherein the housing further comprises:
housing sides coupled to the housing back wall at obtuse angles and to a point on the housing at about the light source at which the respective sides of the housing form acute angles with respect to a light guide optically coupled to the light source.

21. The luminaire of claim 12, wherein the light source and the radio frequency circuitry are located outside the RF radiation transparent volume.

22. The luminaire of claim 12, further comprising:
a reflector configured to direct light emitted by the light source toward the housing output aperture.

23. The luminaire of claim 22, wherein the light source is further configured to emit light toward the reflector.
